(19) United States
(12) Patent Application Publication
(10) Pub. No.: US 2025/0349923 A1
(43) Pub. Date: Nov. 13, 2025

(54) ENERGY STORAGE SYSTEM

(71) Applicant: LITE-ON TECHNOLOGY CORPORATION, Taipei (TW)

(72) Inventors: Yung-Hsiang CHEN, Taipei (TW); Ching-Te Chu, Taipei (TW)

(21) Appl. No.: 18/731,390

(22) Filed: Jun. 3, 2024

(30) Foreign Application Priority Data
May 8, 2024 (TW) 113116973

(51) Int. Cl. H01M 10/617; H01M 10/6551; H01M 10/6563; H01M 10/6566

(52) U.S. Cl. CPC H01M 10/617; H01M 10/6551; H01M 10/6563; H01M 10/6566

(57) ABSTRACT

An energy storage system including a battery module and a temperature difference adjustment structure is provided. The temperature difference adjustment structure is provided on the battery module, and the temperature difference adjustment structure includes a first plate and a second plate. The second plate includes a first side and a second side opposite to the first side. The first side is connected to the first plate, and the second side is closer to the battery module relative to the first side.

This application claims the benefit of Taiwan application Serial No. 113116973, filed May 8, 2024, the subject matter of which is incorporated herein by reference.

### BACKGROUND OF THE INVENTION

### Field of the Invention

The invention relates in general to an energy storage system.

### Description of the Related Art

The battery modules currently used in energy storage systems and vehicles are not equipped with a single lithium battery for charge and discharge, but have multiple lithium batteries in series. However, when using a series structure, the temperature of the battery modules may be uneven. When the temperature difference between lithium batteries is too large for a long time, it will affect the lifespan of the batteries.

### SUMMARY OF THE INVENTION

The invention relates to an energy storage system. The energy storage system includes a temperature difference adjustment structure to adjust the temperature difference in different sections of the battery module.

According to one aspect of the present invention, an energy storage system including a battery module and a temperature difference adjustment structure is provided. The temperature difference adjustment structure is provided on the battery module, and the temperature difference adjustment structure includes a first plate and a second plate. The second plate includes a first side and a second side opposite to the first side. The first side is connected to the first plate, and the second side is closer to the battery module relative to the first side.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an energy storage system according to an embodiment of the present invention.

FIGS. 2A to 2E are schematic diagrams of a temperature difference adjustment structure according to an embodiment of the present invention.

FIGS. 3A to 3D respectively illustrate schematic diagrams of a temperature difference adjustment structures according to different embodiments of the present invention.

FIGS. 4A to 4E respectively illustrate schematic diagrams of a temperature difference adjustment structure according to different embodiments of the present invention.

FIGS. 5A to 5B respectively illustrate schematic diagrams of a temperature difference adjustment structure according to different embodiments of the present invention.

### DETAILED DESCRIPTION OF THE INVENTION

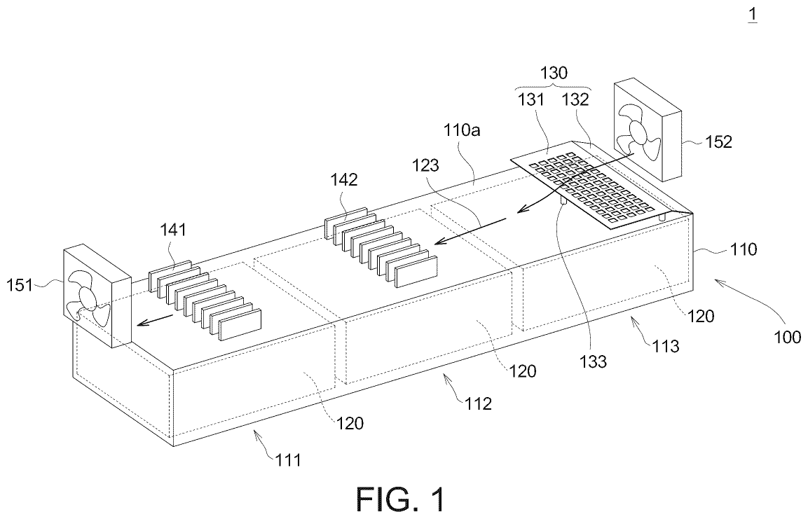

Referring to FIG. 1, a schematic diagram of an energy storage system 1 according to an embodiment of the present invention is illustrated. The energy storage system 1 may include a battery module 100, a temperature difference adjustment structure 130, a first heat sink 141, a second heat sink 142, a first fan 151 and a second fan 152. The temperature difference adjustment structure 130 includes a first plate 131 and a second plate 132. The temperature difference adjustment structure 130 includes heat dissipation holes, and the heat dissipation holes can be provided on the first plate 131, the second plate 132 or the first plate 131 and the second plate 132. The number of the heat dissipation holes can be adjusted according to requirements.

The temperature difference adjustment structure 130 is provided on a battery module 100 to adjust the temperature difference in different sections of the battery module 100. The battery module 100 can have a structure in which multiple battery units 120 are connected in series or in parallel, which can increase the power and the capacity of the battery module 100 and reduce the internal resistance, thereby extending the power supply time. However, when the battery units 120 are connected in series or in parallel, attention should be paid to the consistency of the battery module 100. For example, when the battery units 120 are connected in series, the temperature of the battery module 100 may be uneven. When the battery module 100 is exposed to an excessive temperature difference for a long time, the lifespan of the battery module 100 will be affected. The battery unit 120 may be a lithium battery, for example.

Especially the rectangular battery module 100 is likely to have significant temperature differences in at least three sections. Referring to FIG. 1, the battery module 100 includes a housing 110 and a plurality of battery units 120 located inside the housing 110. The housing 110 includes at least three sections including a front section 111, a middle section 112 and a rear section 113. The temperature differences of the battery cells 120 among the sections will affect the charging and discharging efficiency and lifespan of the battery module 100. Therefore, when controlling the temperature of the battery module 100, it is not only necessary to maintain the temperature of the battery unit 120 itself in each section within a standard range, but also to maintain the temperature differences of the battery unit 120 among the sections within a predetermined temperature difference range, so as to maintain the consistency of the battery module 100 among the sections.

Referring to FIG. 1, the first fan 151 is provided at the front end of the housing 110, and the second fan 152 is provided at the rear end of the housing 110. The first fan 151 and the second fan 152 are used to guide a cooling airflow 123 through the upper surface 110a of the casing 110, for example, to guide the cooling airflow 123 to move from the rear end to the front end of the casing 110 to take away excess heat energy dissipated from the upper surface 110a. The first fan 151 is, for example, an exhaust fan, and the second fan 152 is, for example, an air intake fan.

In some embodiments, when the temperature difference adjustment structure 130 is not provided and the airflow 123 formed by the first fan 151 and the second fan 152 is simply used to reduce the temperature of the battery module 100, the temperature differences of the battery unit 120 among the sections are still relatively high. For example, the housing temperature of the front section 111 and the middle section 112 is measured to be about 56.5° C., and the housing temperature of the rear section 113 is measured to be about 48.4° C. The temperature difference between the two sections is about 8.1° C. This is because the battery unit 120 in the rear section 113 is close to the second fan 152, so that the airflow 123 generated by the second fan 152 with higher cooling efficiency directly dissipates heat from the battery unit 120 in the rear section 113, while the battery units 120 in the front section 111 and the middle section 112 are far away from the second fan 152, so that the airflow 123 generated by the second fan 152 with higher cooling efficiency cannot directly dissipate heat from the battery units 120 in the front section 111 and the middle section 112. Therefore, in order to prevent the housing temperature of the rear section 113 from being significantly lower than the housing temperature of the front section 111 and the middle section 112, the temperature difference adjustment structure 130 is disposed close to the second fan 152 (i.e., the intake end of airflow) to reduce the temperature differences of the battery unit 120 among the sections.

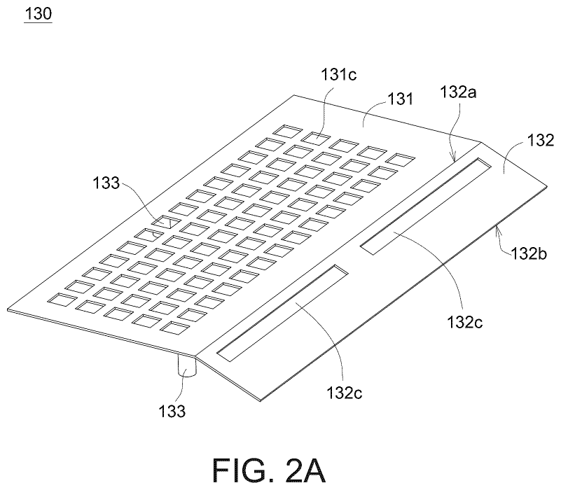

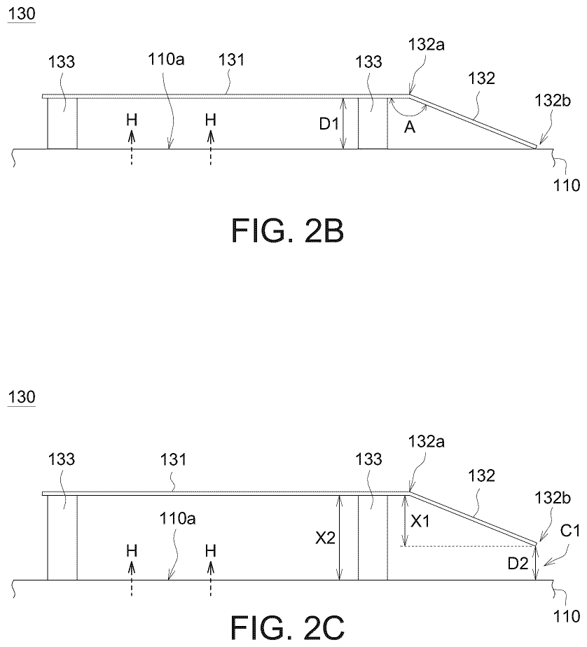

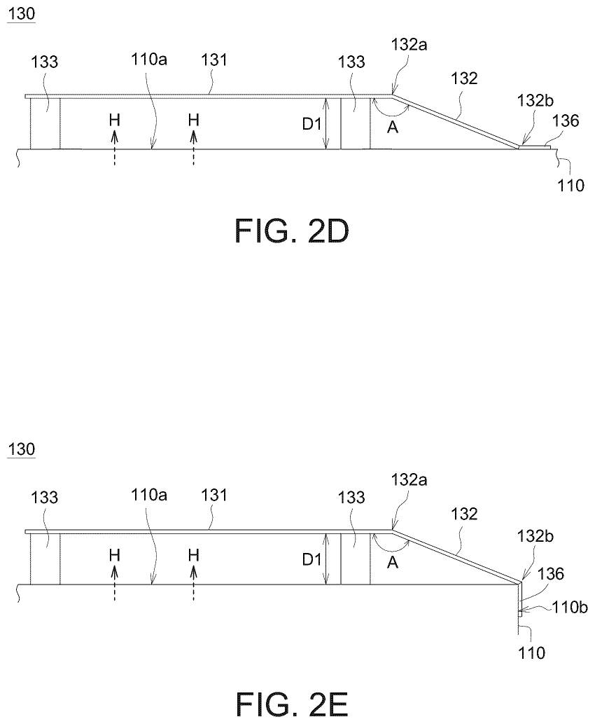

Referring to FIGS. 1 and 2A, the temperature difference adjustment structure 130, disposed on an upper surface 110a of the housing 110, includes a first plate 131 and a second plate 132. The first plate 131 includes a plurality of heat dissipation holes 131c. The second plate 132 includes a first side 132a and a second side 132b opposite to the first side 132a. The first side 132a is connected to the first plate 131. The second plate 132 is tilted relative to the first plate 131 so that the second side 132b is closer to the battery module 100 relative to the first side 132a. The first plate 131 is substantially parallel to the upper surface 110a of the housing 110, and the second plate 132 extends obliquely toward the upper surface 110a of the housing 110.

In addition, the heat dissipation holes 131c are provided in the first plate 131. The heat dissipation holes 131c are, for example, square, circular, diamond-shaped, trapezoidal, rectangular, triangular, hexagonal or other polygonal openings. The heat dissipation holes 131c can allow the rising hot air to dissipate above the first plate 131, and part of the rising hot air is blocked by the first plate 131 and maintained below the first plate 131, thereby regulating the temperature difference of the battery module 100. In addition, the heat dissipation holes 132c are provided on the second plate 132. The heat dissipation holes 132c are adjacent to the first side 132a (or the first plate 131) and away from the second side 132b (or the battery module 100).

In some embodiments, when the number or density of the heat dissipation holes 131c and 132c is higher, it means that the opening ratio of the first plate 131 and the second plate 132 is higher, and the amount of the rising hot air being dissipated increases, thereby reducing the temperature of the sections covered by the first plate 131 and the second plate 132. On the contrary, when the number or density of the heat dissipation holes 131c and 132c is lower, it means that the opening ratio of the first plate 131 and the second plate 132 is lower, and the amount of rising hot air being dissipated decreases, thereby increasing the temperature of the sections covered by the first plate 131 and the second plate 132. In some embodiments, the opening ratio of the first plate 131 and the second plate 132 is, for example, between 20% and 60%, such as 45%, but the present invention is not limited thereto.

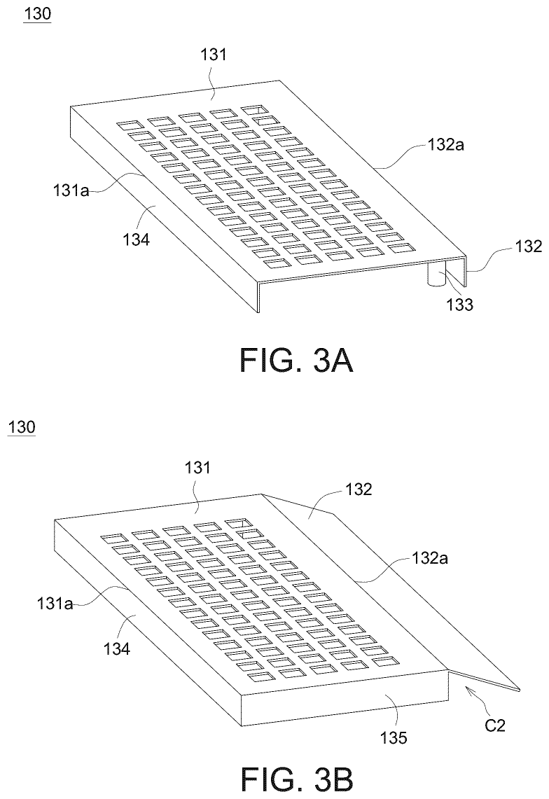

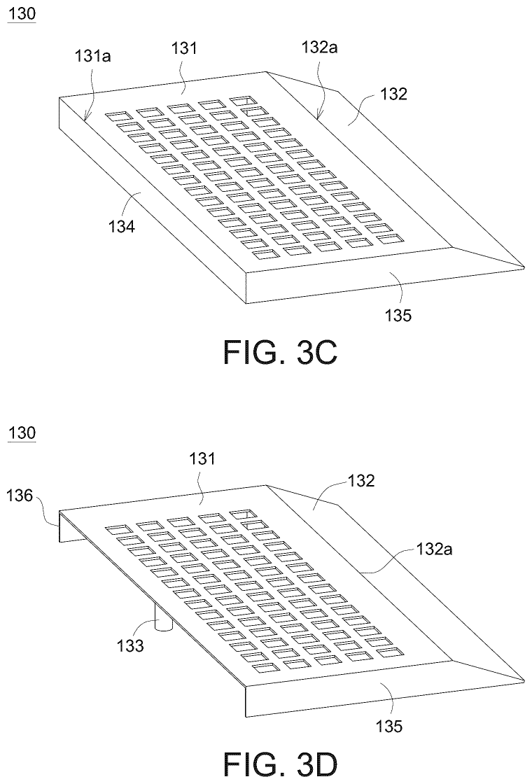

In addition, the second plate 132 tilts at a predetermined angle and a predetermined length relative to the first plate 131, so that the second plate 132 can block the cooling air introduced by the second fan 152 to avoid excessive cooling air entering the section covered by the first plate 131 that requires temperature control. In some embodiments, the predetermined angle of inclination is, for example, between 10 degrees and 45 degrees. The second plate 132 can be a flat plate, a curved plate or a plate with a flow guide structure. As shown in FIG. 2B, a distance D1 is formed between the first plate 131 and the upper surface 110a of the housing 110, and there is an included angle A between the first plate 131 and the second plate 132. The included angle A is greater than or equal to 90 degrees and less than 180 degrees. For example, in FIG. 3A, the included angle between the first plate 131 and the second plate 132 is, for example, 90 degrees.

In addition, the temperature difference adjustment structure 130 may further include a support member 133, the number of which may be one or more. The support member 133 is disposed between the first plate 131 and the battery module 100 (i.e., the upper surface 110a of the housing 110). The first plate 131 is separated from the battery module 100 (i.e., the upper surface 110a of the housing 110) by a distance (not in contact with the battery module 100) through the support member 133, thereby controlling the temperature difference of the battery module 100. Referring to FIGS. 2B and 2C, schematic side views of the temperature difference adjustment structure 130 according to two embodiments of the present invention are respectively illustrated. The support member 133 is, for example, a fixed column. The fixed column has a height (for example, between 5 mm and 40 mm) and a screw hole (not shown in the figure), and a fastener (such as a screw) is configured to pass through the through hole (not shown in the figure) of the first plate 131 and be fixed in the screw hole.

Referring to FIGS. 2B and 2C. In FIG. 2B, the height of the support member 133 is substantially equal to the height of the first side 132a of the second plate 132 relative to the second side 132b, such that the second side 132b of the second plate 132 is, for example, in contact with or close to the upper surface 110a of the housing 110. The height X2 of the support member 133 may be the same as the distance D1 between the first plate 131 and the upper surface 110a of the housing 110. The height X2 of the support member 133 is related to the speed at which the rising hot air H dissipates. When the height X2 of the support member 133 is lower, the rising hot air H has a relatively low distance to dissipate heat, so the speed of the rising hot air H dissipating into the air is relatively slow. In the contrast, when the height X2 of the support member 133 is high, the rising hot air H has a relatively high distance to dissipate heat, so the speed of the rising hot air H dissipating into the air is relatively fast. Therefore, by controlling the height X2 of the support member 133, the heat energy contained in unit volume of the section can be increased or decreased, thereby controlling the temperature of the sections covered by the first plate 131.

In addition, the support member 133 may be a magnetic support member, such as a magnet or a cylinder containing ferromagnetic material. The first plate 131 can be fixed on the support member 133 through magnetic attraction without the need of fasteners. On the other hand, in FIG. 20, when the height X2 of the support member 133 is greater than the height X1 of the first side 132a of the second plate 132 relative to the second side 132b, the second side 132b of the second plate 132 has a gap C1 relative to the upper surface 110a of the housing 110, so that the second side 132b of the second plate 132 and the upper surface 110a of the housing 110 are not completely closed. Therefore, part of the airflow can be introduced from the gap C1 of the second side 132b of the second plate 132 into the section covered by the second plate 132 to reduce the temperature of the section covered by the first plate 131. Here, a distance D2 is formed between the second side 132b of the second plate 132 and the upper surface 110a of the housing 110.

In FIGS. 2D and 2E, the temperature difference adjustment structure 130 further includes a third plate 136. The third plate 136 is connected to the second side 132b of the second plate 132, and the third plate 136 is attached to the battery module 100 (i.e., the upper surface 110a of the housing 110). The temperature difference adjustment structure 130 can more firmly contact with the battery module 100 through the third plate 136. The third plate 136 can be designed to be parallel to the first plate 131 and fit on the upper side of the battery module 100, or the third plate 136 can be designed to be perpendicular to the first plate 131 and fit to the side 110b of the battery module 100.

Refer to FIG. 1. In addition to the temperature difference adjustment structure 130, the energy storage system 1 may further include a first heat sink 141 and a second heat sink 142 respectively disposed on the upper surface 110a of the housing 110. The first heat sink 141 and the second heat sink 142 are, for example, metal heat dissipation fins of the same or different areas. By controlling the number and height of the heat dissipation fins, the heat dissipation efficiency of the heat dissipation fins is changed. At the same time, the first heat sink 141 and the second heat sink 142 can guide the cooling airflow 123 to move from the rear end to the front end of the housing 110 through the first fan 151 and the second fan 152 to take away the excess heat energy on the first heat sink 141 and the second heat sink 142, thereby reducing the housing temperature of the battery unit 120 in the front section 111 or the middle section 112.

In some embodiments, when the temperature difference adjustment structure 130 and the first heat sink 141 and the second heat sink 142 are installed, the housing temperatures of the front section 111 and the middle section 112 are measured to be approximately 53.7° C. (drop of about 2.8° C.), the housing temperature of the rear section 113 is about 50.8° C. (increase of about 2.4° C.). The temperature difference between the two sections is approximately 2.9° C., within a predetermined temperature difference range, to maintain the consistency of the battery module 100. Referring to FIG. 1, the battery module 100 has a first battery unit (such as one of the battery units 120 of the rear section 113) and a second battery unit (such as another one of the battery units 120 of the front section 111 or the middle section 112). The vertical projection of the first plate 131 on the battery module 100 overlaps with the first battery unit, and the vertical projections of the first and second heat sinks 141 and 142 on the battery module 100 overlap with the second battery unit respectively.

Referring to FIGS. 3A to 3D, schematic diagrams of the temperature difference adjustment structure 130 according to different embodiments of the present invention are respectively illustrated. In FIG. 3A, in addition to the first plate 131 and the second plate 132, the support member of the temperature difference adjustment structure 130 includes a front plate 134. The front plate 134 is connected to the front side 131a of the first plate 131 and extends vertically relative to the first plate 131 to form an L-shaped structure. In FIG. 3B, the support member of the temperature difference adjustment structure 130 includes a front plate 134 and two side plates 135. The front plate 134 is connected to the two side plates 135 and is completely closed, but the two side plates 135 are not connected to the second plate 132 with a gap C2 therebetween. In FIG. 3C, the front plate 134 is connected to the two side plates 135 and is completely closed without the gap C2. In FIG. 3D, the two side plates 135 are connected to opposite sides of the first plate 131 and the second plate 132 and extend vertically relative to the first plate 131 to form a hat-shaped (Inverted U-shaped) structure. The structures of the above four embodiments can increase the housing temperature of the battery unit 120 in the section covered by the first plate 131 and keep the temperature difference of the battery module 100 within a predetermined temperature difference range to maintain the consistency of the battery module 100 among the sections.

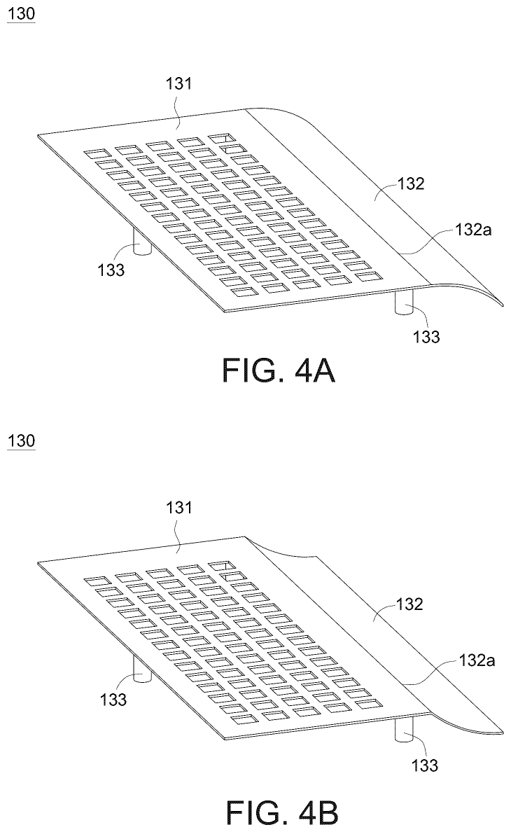

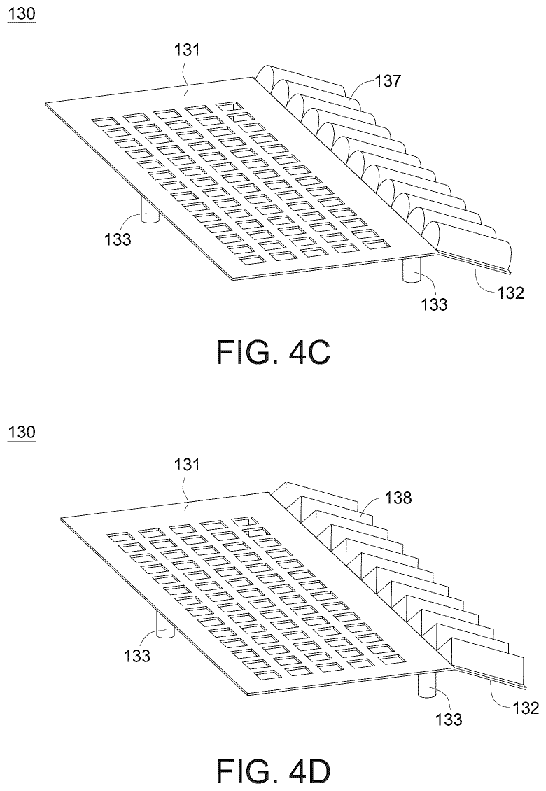

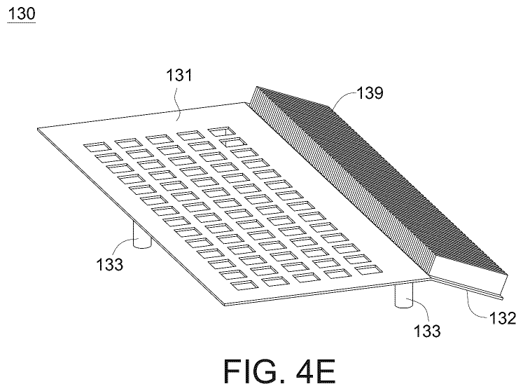

Referring to FIGS. 4A to 4E, schematic diagrams of the temperature difference adjustment structure 130 according to different embodiments of the present invention are respectively illustrated. In FIG. 4A, the second plate 132 is an arc-shaped plate, which extends from the first plate 131 and has an arc surface, and the arc surface is bent downward to have an upper turning point. In FIG. 4B, the second plate 132 is an arc-shaped plate, which extends from the first plate 131 and has an arc surface, and the arc surface is bent upward to have a lower turning point. In FIG. 4C, in addition to the first plate 131 and the second plate 132, the temperature difference adjustment structure 130 also includes one or more semi-cylindrical structures 137, which are arranged on the second plate 132. Each surface of the semi-cylindrical structures 137 can be formed into a semi-cylindrical shape or other possible shapes, and the surfaces of the semi-cylindrical structures 137 can be connected to each other or separated by a distance. In FIG. 4D, in addition to the first plate 131 and the second plate 132, the temperature difference adjustment structure 130 also includes one or more triangular prism structures 138, which are arranged on the second plate 132. Each surface of the triangular prism structures 138 can be connected to each other or separated by a distance. In FIG. 4E, in addition to the first plate 131 and the second plate 132, the temperature difference adjustment structure 130 also includes one or more fin structures 139, which are disposed on the second plate 132. Each of the fin structures 139 is a rectangle or other possible shapes, and there is a gap between two adjacent fins. The structures of the above five embodiments can increase wind resistance or form a stable air flow, so that the temperature difference of the battery module 100 is within a predetermined temperature difference range to maintain the consistency of the battery module 100 among the sections.

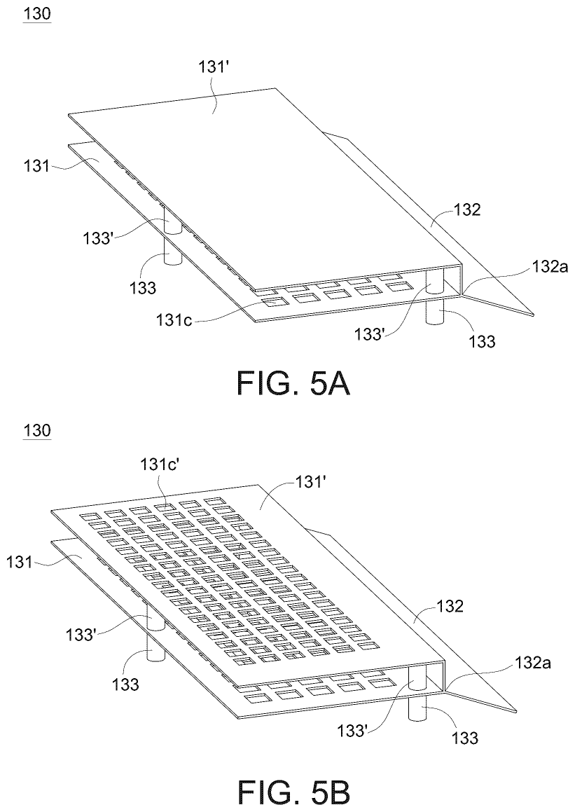

Referring to FIGS. 5A to 5B, schematic diagrams of the temperature difference adjustment structure 130 according to different embodiments of the present invention are respectively illustrated. In FIG. 5A, in addition to the first plate 131 and the second plate 132, the temperature difference adjustment structure 130 also includes a fourth plate 131′ and at least one supporting member 133′. The vertical projection of the fourth plate 131′ on the battery module 100 overlaps with the first plate 131. The fourth plate 131′ can be a plate added to the first plate 131. The fourth plate 131′ covers the first plate 131 and is supported by the support 133′ to separate from the first plate 131 by a distance (for example, 5 mm to 20 mm). In one embodiment, heat dissipation holes 131c on the first layer are provided to allow the rising hot air to dissipate away from the first plate 131. The fourth plate 131′ on the second layer is, for example, a laminate without heat dissipation holes (see FIG. 5A) or a laminate with heat dissipation holes 131c′ (see FIG. 5B). Therefore, in FIG. 5A, the rising hot air passing through the first plate 131 is blocked by the fourth plate 131′ and is maintained between the first plate 131 and the fourth plate 131′, or, in the FIG. 5B, part of the rising hot air passing through the first plate 131 is dissipated through the heat dissipation holes 131c′ of the fourth plate 131′, and part of the rising hot air is blocked by the fourth plate 131′ and is maintained between the first plate 131 and the fourth plate 131′. The structures in the above two embodiments can increase the housing temperature of the battery unit 120 in the section covered by the first plate 131 and keep the temperature difference of the battery module 100 within a predetermined temperature difference range to maintain the consistency of the battery module 100 among the sections.

According to the embodiments of the present invention, the energy storage system and the temperature difference adjustment structure can adjust the temperature differences in different sections of the battery module and prevent temperature difference of the battery units from being too large for a long time, such that the lifespan of the battery module can be improved. Especially for rectangular battery modules, there are significant temperature differences in at least three sections. By effectively controlling the battery temperature in different sections and reducing the temperature differences in different sections, the charge and discharge efficiency, lifespan and reliability of the battery module can be improved and the battery maintenance cost can be reduced.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An energy storage system, comprising:
a battery module; and
a temperature difference adjustment structure provided on the battery module, the temperature difference adjustment structure comprising:
a first plate; and
a second plate, wherein the second plate includes a first side and a second side opposite to the first side, the first side is connected to the first plate, and the second side is closer to the battery module relative to the first side.

2. The energy storage system of claim 1, wherein the temperature difference adjustment structure comprises a heat dissipation hole.

3. The energy storage system of claim 1, wherein a distance is formed between the first plate and the battery module.

4. The energy storage system of claim 1, wherein the temperature difference adjustment structure further comprises a support member connected to the first plate and disposed between the first plate and the battery module.

5. The energy storage system of claim 4, wherein a height of the support member is greater than or equal to a height of the first side of the second plate relative to the second side.

6. The energy storage system of claim 1, wherein an included angle is formed between the first plate and the second plate, and the included angle is greater than or equal to 90 degrees and less than 180 degrees.

7. The energy storage system of claim 1, wherein the temperature difference adjustment structure further includes a third plate, the third plate is connected to the second side, and the third plate is attached to the battery module.

8. The energy storage system of claim 1, wherein the energy storage system further includes a first fan and a second fan, and the battery module comprises a housing located between the first fan and the second fan, wherein the first plate and the second plate are disposed on an upper surface of the housing and the second plate extends from the first side toward the upper surface.

9. The energy storage system of claim 1, wherein the second plate has a flat surface, a curved surface or a flow guide structure.

10. The energy storage system of claim 1, wherein the energy storage system further comprises a heat sink, the battery module has a first battery unit and a second battery unit, and a vertical projection of the first plate on the battery module overlaps with the first battery unit, and a vertical projection of the heat sink on the battery module overlaps with the second battery unit.

11. The energy storage system of claim 1, wherein the temperature difference adjustment structure further comprises:
a fourth plate, wherein a vertical projection of the fourth plate on the battery module overlaps the first plate, and the fourth plate is separated from the first plate by a distance.
